(19) United States
(12) Patent Application Publication
(10) Pub. No.: US 2005/0197862 A1
(43) Pub. Date: Sep. 8, 2005

(54) Medical data analysis system

(75) Inventors: Daniel Paterson, Westwood, MA (US); Dane Morgan, Somerville, MA (US); Gerbrand Ceder, Wellesley, MA (US); Stan Norton, West Newbury, MA (US)

Correspondence Address: WILMER CUTLER PICKERING HALE AND DORR LLP, 60 STATE STREET, BOSTON, MA, 02109, US

(73) Assignee: PharMetrics, Inc., Watertown, MA (US)

(21) Appl. No.: 11/047,467

(22) Filed: Jan. 28, 2005

Related U.S. Application Data
(60) Provisional application No. 60/540,390, filed on Jan. 30, 2004.

(51) Int. Cl. G06F 17/60

(52) U.S. Cl. 705/2

(57) ABSTRACT

Prediction methods including statistical and artificial intelligence methods to predict the prescribing behavior and characteristics and size of patient populations under the care of health care providers from limited data, based on processes developed on integrated medical and pharmaceutical claims data. Prescribers can be classified into groups and subgroups, and marketing recommendations can be made to organizations with interest in the drug prescriptions based on prescription data; sales force effectiveness and marketing message effectiveness products can also be developed.

### CROSS REFERENCE TO RELATED APPLICATION

This application claims priority to provisional application Ser. No. 60/540,390, filed Jan. 30, 2004.

### BACKGROUND OF THE INVENTION

Privacy concerns are important in the health care industry, so many records of patient-provider interactions are not available for analysis, or for constructing targeted marketing strategies. People interested in the sales and use of prescriptions drugs, such as pharmaceutical companies, governments, health care insurers, and financial institutions, often have to work with partial and incomplete data when analyzing prescription behavior of providers or groups of providers.

### SUMMARY OF THE INVENTION

The present invention includes methods and systems for predicting prescribing behavior of health care providers from limited data. Prediction methods can include statistical or artificial intelligence methods to predict the prescribing behavior of health care providers. As a result, prescribers can be classified into groups and subgroups, and marketing decisions can be tailored to different groups of prescribers.

Currently, pharmaceutical companies tend to target the highest volume drug prescribers with promotional material, even though it is possible that these physicians already prescribe at a high rate, and are therefore unlikely to increase their prescription volume. It would be useful to be able to predict which physicians have a low treatment rate (either due to large number of untreated patients, or large numbers of under-treated patients who have poor compliance or persistence on their prescribed therapy), as these physicians may offer, from a marketing perspective, the highest potential for growth in their prescription volume.

A problem faced by pharmaceutical companies is that they currently have script (prescription) data that identifies doctors, but do not have access to more detailed claims data. It would be desirable for pharmaceutical companies to be able to predict total prescriber potential for providers from script data only.

One of many prediction methods may be used, such as regression methods, clustering methods, and neural networks. The prediction methods can be trained on more complete data sets so that predictions can be made using limited data sets. For example, a prediction method for predicting a treatment rate from script data can be trained using script data and known treatment rates obtained from currently available and more complete medical claims data. Once the prediction method is trained, it can be used for predicting treatment rates from script data, even without claims data.

Aspects of the invention can be implemented as software that can predict treatment rates from a less complete set of data, such as script data, using prediction methods trained on more complete data, such as claims data. In another aspect, a service can be used to provide interested parties with predictions of provider treatment rates based on their data.

A further embodiment includes using prediction methods to predict providers who might be valuable to contact for pharmaceutical companies based on only script data. This involves a method which generally categorizes providers by treatment rate, including identifying potentially valuable providers to contact based on predicted treatment rates, as well as, but not limited to, such information as total prescription volume and drug value. In this embodiment, the prediction methods can be used to predict the increased sales associated with pharmaceutical companies targeting specific providers for advertising or other promotional activities. Marketing could be directed differently to different providers, such as marketing aimed at reinforcing providers with high treatment rates, and aimed at encouraging alternative treatments for providers with low treatment rates.

The method as described above can be implemented through the use of a computing network with programmed, general-purpose hardware, dedicated hardware, or a combination of software and dedicated hardware. The system can include a processor, such as a computer, server, or other programmed logic, that can interact with stored data that can be kept on a storage medium, such as an optical or magnetic disc.

Other features and advantages will become apparent from the following detailed description, drawings, and claims.

### BRIEF DESCRIPTION OF DRAWINGS

FIG. 1 is a flow chart illustrating how a method can be build to predict treatment rate based on pharmacological data only.

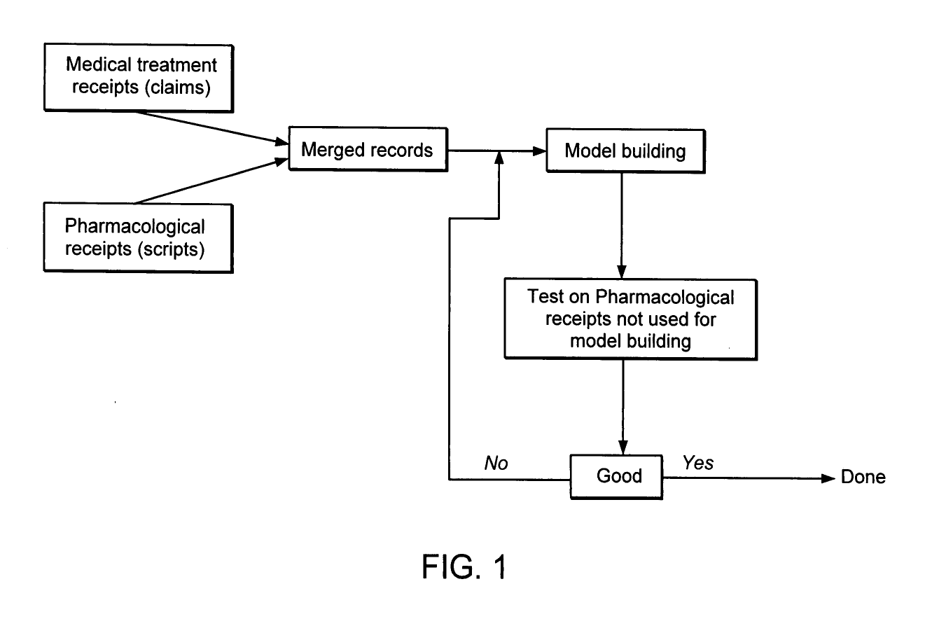

FIG. 2 shows results of statistical test of methods for hyperlipidemia, with false positives and false negatives.

### DETAILED DESCRIPTION

Pharmaceutical companies generally have access to prescriber-level prescription data (also referred to here as “script data”), which can include script activity, ratios of drug use by therapeutic class and brand, average length of therapy by drug and class, average daily (or weekly) dosing by drug, persistency by drug class and drug, prescriber specialty, and region of the country.

Patient-centric claims data is non-personally identifiable data aggregated from medical plans and can include a wide range of information, such as health care provider identifier, provider specialty, patient age, patient gender, patient diagnosis, patient treatment, ratio of diagnosed patients to treated patients by disease (and co-morbidity), treatment type (drug class) by diagnosis and co-morbidity, dose by diagnosis and co-morbidity, length of therapy versus diagnosis and co-morbidity, concomitant therapy by diagnosis (percent of treated with multiple therapies), treated vs. untreated ratios, compliance and persistency by diagnosis and co-morbidity, testing to treatment ratio (lab test for cholesterol versus drug therapy), and ratios of different drug therapies (by diagnosis) to each other.

Using claims data, it is possible to determine the average prescribing behavior of the medical care provider, because the claims data indicate how many patients the provider has seen and the number of prescriptions given for particular drugs. As used here, a treatment rate is a percent of patients treated a certain way, and can include for a class of diseases and class of drugs refers, a fraction of patients diagnosed with a disease from the disease class that are treated with a drug from the drug class. Claims data can be used to determine which providers have higher than average treatment rates, and which providers have lower than average treatment rates. Treatment rate information is useful to pharmaceutical companies because it allows them to focus marketing campaigns on health care providers that underprescribe their drugs, and possibly providing reinforcing marketing activity to those who already prescribe.

With only script data, treatment rates cannot be determined for a given provider, because untreated patients are not included in the script data. While pharmaceutical companies have information on the prescription volume of a physician, they have no information what patient volume that was derived from.

The present invention relates to predicting provider behavior based on a limited data set using a prediction method trained by a more complete data set. Specific embodiments can vary depending on choices for the provider behavior predicted, the complete and limited data sets, and the prediction method used. Specific embodiments can also differ on how the predicted provider behavior is quantified and utilized to create a service or product.

In one embodiment, the predicted provider behavior is the treatment rate based on treatment of a disease with any drug. For example, a treatment rate for hyperlipidemia (high cholesterol) for a given provider could be determined as the fraction of patients diagnosed with hyperlipidemia who are prescribed, by that same provider, with any drug generally prescribed to treat hyperlipidemia. A provider who diagnoses 100 patients in a year with hyperlipidemia, and prescribes hyperlipidemia treating drugs to 50 of those patients, would have a treatment rate of 50% (or 0.5) for that year. In other embodiments, treatment rate could be another selected method of treatment or groups of methods.

In one embodiment, the more complete data set is the medical claims data and the more limited set is the script data. The more complete data set should contain enough information to train the prediction method so that predictions can be made with a more limited data set. The more complete data set is typically, but not necessarily, a superset of the limited data. In this exemplary embodiment, the script data is contained in the claims data, allowing one to establish relationships between the script data and claims data that is not also in the script data.

One prediction method that can be used includes using a regression method, where the latter refers to some functional relationship between independent inputs (X) and dependent outputs (Y), where the parameters of the functional relationship are fit based on known data. For example, a simple linear fit can be found with linear regression, where the slope and intercept are the unknown parameters determined by regression.

As an example, consider the case of hyperlipidemia (high cholesterol). One approach is to collect all claims data for a set of providers for a time period, such as two years. Among these providers, all providers that have at least one patient that was diagnosed with hyperlipidemia are kept in the data set. For each patient diagnosed, the system associates the provider who first diagnosed the patient with that patient, and then checks if that provider has ever treated the patient with a drug in the class of hyperlipidemia drugs. The class of hyperlipidemia drugs can be determined from a list. If the provider did treat the patient with a drug in the class, a treatment variable value of 1 is assigned for that patient and provider. If the provider did not treat the patient with a drug in the class, then a treatment variable value of 0 is assigned for that patient and provider. The average value of the treatment variable over all patients diagnosed by a specific provider is that provider's treatment rate (for the given disease, drug classes, and time period). It is the goal of the algorithms, programs and devices in this invention to be able to predict that treatment rate from the lesser information that is contained in script data for future activity, to predict changes, and to predict behavior for providers not previously considered. In the embodiment that uses regression analysis, the dependent variable Y is the treatment rate, and the independent variables X are some or all of the variables that come from script data only. There are many possible choices of what parts of the script data to use, but it would generally consist of the same providers and patients and cover the same period of time as used in the determination of treatment rate above. Once the regression analysis has been performed on this data, the resulting model can be used to predict treatment rates for the same or entirely new providers in similar or new situations based on only script data.

In one embodiment, the dependent variables are the total number of prescriptions of each distinct name brand drug prescribed in the script data set. This data ignores the size of the prescriptions and differences between drugs that are not distinguished in the brand name categories. The number of prescriptions of each name brand drug for a given provider during a specific period are referred to as that provider's prescription profile. The prescription profile might be restricted to just hyperlipidemia drugs, or consist of all types of drugs. In this embodiment, the prescription profile will be the independent variables X in the regression.

A regression of Y on X is performed to determine the relations R, where Y=R(X). If the relationship is linear, e.g., Y=R₁X₁+R₂X₂+ . . . RₙXₙ, where Xₙ are the n variables that are used, then R is a linear function. This method would be multivariate linear regression of some form. If R is in a nonlinear function, R could be represented with a neural network.

A number of issues should be considered. One issue is using good data for the regression. Certain data points can be removed if they alter the effectiveness of the prediction methods. For example, providers with very few patients, or drugs that are prescribed very infrequently, might be excluded from the independent variables. In both cases the small numbers involved can make the data uncertain and introduce inaccuracy in the regression.

There are many choices for the relationship R, even just among regression methods. For only linear regression methods, there are still a number of options. One straightforward approach is a well-known least-squares multivariate linear regression. In this case, the treatment rate is regressed for each provider against the prediction profile for each provider. This process produces a regression coefficient for each brand name drug included in the prescription profile. The regression coefficients define R, and allow prediction from script data. This means that given a new provider, with only script data and a prescription profile X_{new}, we can predict a treatment rate T_{pred} for the new provider by the relation T_{pred}=R(X_{new}). If the regression is accurate then the predicted treatment rate, T_{pred}, will be close to the true treatment rate for the new provider, T_{new}.

Problems can arise using a basic least-squares multivariate linear regression. For example, there may be many more brand name drugs than providers, in which case unique coefficients for each brand name cannot be determined by basic least-squares multivariate linear regression. One solution is to remove specific brand names from the independent variables X, for example, only keeping the brand names that are prescribed most often. A method of focusing in on the most important degrees of freedom in the brand name data is principle component regression (PCR) and the closely related technique, partial least squares (PLS). These methods can identify the most important linear combinations of the brand name prescription data to explain the brand name data variance (PCR) or the brand name—treatment rate covariance (PLS). The most important linear combinations are called latent variables and each latent variable included is an independent variable in the regression. Results can be optimized by choosing the right number of latent variables. Other extensions of simple linear methods can be used, including, but not limited to, nonlinear weighting schemes and pre-clustering.

There are multiple ways for selecting how predicted provider behavior is quantified and utilized to create a service or product. In terms of quantification, it is important to show that the regression function R actually has some predictive ability. One valuable quantification is to try to predict the providers within the lowest 33% of all providers when ordered by treatment rate. These providers may be considered underprescribers and may be valuable for pharmaceutical companies to target.

The prediction method can be used in a number of ways to create products and services based on these treatment rates. Using the results of these predictive algorithms a pharmaceutical company could alter the deployment of its sales forces by moving from targeting the high prescribing physicians, as they do today, to targeting high potential physicians. This new high priority group could include both current high prescribers and non-high prescribers, but its make-up would be driven by the group of physicians whose patients have the greatest potential need for the drug of interest, the group with the greatest potential to prescribe the drug. The process could similarly be used to further refine the targeting of the current high prescriber group. Physicians who today would be targeted equally based on their current prescribing volume could be segmented by high, medium, and low additional potential. The process could also be used to further segment these high prescribing physicians based on the key behaviors that are keeping them from reaching their prescribing potential.

The three main behaviors that can contribute to unmet potential, and can be differentially revealed by the processes and systems described here are low treatment rates, low patient persistence on therapy (the patients do not stay on therapy), and low compliance with therapy (the patients do not regularly take their medication). Once a pharmaceutical company has this information, it can use the information to alter sales force allocations (who gets visited and how often), as well as the messaging to the physicians (what is said to the physician during the visit). The information can also be used to target and design medical education programs as well as target and design special programs meant to improve these behaviors.

The product that will be created with the algorithms can take a number of forms.

Software with the processes embedded can be supplied electronically or in memory, such as on a magnetic or optical disc, to an interested customer, such as a pharmaceutical company, to use the software to process physician-level prescription data to produce the results mentioned above.

A “service bureau” can be created, whereby a service provider run the processes described here against physician-level prescription data in possession of a an entity seeking the service, such as a pharmaceutical company.

A sales force effectiveness product can be developed by a service provider or in conjunction with a business ally where the results of the processes described here are used to make specific recommendations on sales force allocation or messaging changes, or to design new medical education programs or intervention programs for a client, such as a pharmaceutical company.

### EXAMPLES OF ANALYSES

Patients with one or more Hyperlipidemia diagnosis or HMG CoA Reductase Inhibitor drug (statin) during a 9-month period were extracted from 11 medical plans. These plans had true enrollment, days supplied and quantity dispensed information. Patients were continuously enrolled for 21 months, including throughout the 9-month period. For each plan in the hyperlipidemia dataset, the average number of patients per day for each provider (using plan submitted provider) was calculated. Only those providers that had at least 10 unique hyperlipidemia patients in their claims history and had average patients per day of 50 or less were allowed through for this analysis. This assured that the providers were individual providers and not group practices.

Patients were then assigned to a cluster provider identification. “Specialty” is the specialty of the cluster provider identification. There were only four specialties of interest for this analysis: family practitioner, internal medicine, cardiology, and endocrinology. Other provider specialties were excluded.

Patients were considered treated in the presence of a hyperlipidemia diagnosis “and” at least one script for a statin drug “or” the presence of a statin script (with no diagnosis); patients were considered untreated in the presence of a hyperlipidemia diagnosis and no scripts for a statin drug.

Patients in the “treated” group were mapped to their prescribing physicians. The “percent of treated patients” (i.e., number of treated hyperlipidemia patients/total Hyperlipidemia patients) was calculated for each provider. Three provider buckets were created based on 33.3 and 66.6 percentiles. The 33rd and 66th percentiles were used to assure an equal number of observations in all provider buckets. Table 1 of the results section summarizes the findings.

Persistence was expressed as the total days of therapy and was calculated on the 24-month follow up from the time of start on a statin drug to the date of discontinuation, or end of therapy. Switches were ignored since all statins were considered as a single drug.

“Persistence” was calculated at the patient level and then averaged for each provider (cluster provider id). The values were then processed to break out the 33.3 and 66.6 percentiles. The 33rd and 66th percentiles were used to assure an equal number of observations in all provider buckets. Then the provider data was processed again via a univariate by bucket. Table 2 of the results section summarizes findings.

The Compliance (12 month capped method) was calculated using the following formula:
Compliance=Total # of therapy days/Total Duration of Therapy
Therapy days were calculated based on the “days' supplied” information on each pharmacy claim. Duration of therapy was calculated based on the first and the last prescription for the drug, plus the “days' supply” on the last prescription.

The Compliance12MonthCapped value was calculated at the patient level and then averaged for each provider (cluster provider id). The values were then processed to break out the 33.3 and 66.6 percentiles. The 33rd and 66th percentiles were used to assure an equal number of observations in all provider buckets. Then the provider data was processed again via a univariate by bucket. Table 3 of the results section summarizes findings.

### Results/Tables

A dataset of 442,000 hyperlipidemia patients were considered of which 210,417 were treated with statin drugs and 231,585 were untreated. The treated group of patients mapped to 5,832 total prescribing physicians.

TABLE 1
Mean values for “% Treated” buckets:
All Specialties

| Buckets | No. Of Providers | % Treated (mean) |
|---|---|---|
| Bottom Third | 2024 | 27.3% |
| Middle Third | 1922 | 49.8% |
| Upper Third | 1886 | 72.7% |

TABLE 2
Mean values for Persistence buckets

| Buckets | Persistence (mean) |
|---|---|
| Bottom Third | 177 days |
| Middle Third | 293 days |
| Upper Third | 414 days |

TABLE 3
Mean values for Compliance (12 month capped) buckets

| Buckets | Compliance (mean) |
|---|---|
| Bottom Third | 72% |
| Middle Third | 84% |
| Upper Third | 92% |

These results demonstrate that providers can be grouped into significantly distinct buckets based on their treatment behaviors (treatment vs. no treatment, persistence levels and compliance levels).

### EXAMPLE OF REGRESSION

The disease of hyperlipidemia (high cholesterol) is considered. In order to establish treatment rates, claims data was collected for a set of providers for a time period of two years. Among these providers, all providers that had at least one patient that was diagnosed with hyperlipidemia were kept in the data set. For each patient diagnosed, the system associated the provider who first diagnosed the patient with that patient, and then checked if that provider had ever treated the patient with a drug in the class of hyperlipidemia drugs. The class of hyperlipidemia drugs can be determined from a list. If the provider did treat the patient with a drug in the class, a treatment variable value of 1 was assigned for that patient and provider. If the provider did not treat the patient with a drug in the class, then a treatment variable value of 0 was assigned for that patient and provider. The average value of the treatment variable over all patients diagnosed by a specific provider became that provider's treatment rate (for the given disease, drug classes, and time period).

In order to establish a useful quantification of the script data, a script profile is established for each provider for whom the treatment rate has been determined. The script profile includes the total number of prescriptions of each distinct name brand drug prescribed for each provider in the script data set. The drugs can be classified by brand name using a list of brand name categories. A drug is counted as prescribed once if it appears one or more times for a given provider and patient. This data ignores the frequency and size of the prescriptions and differences between drugs that are not distinguished in the brand name categories.

In order to establish a model for predicting treatment rate from script data, a regression was performed. Treatment rates for providers were used as the dependent variable Y. The script profiles for each provider were used as the independent variables X. Y is a nprov×1 column vector, where nprov is the number of providers, and X is an nprov×nbrand matrix, where row i is the prescription profile for provider i, and nbrand is the number of brands. Since there can be a very large number of brands, possibly with quite few prescriptions, a reliable regression cannot be done on all the brands. In practice, only the n most frequently prescribed brands may be tracked, where n is chosen here to be 100. Also, in practice providers are removed from the data set if they have too few overall prescriptions or too few prescriptions of one or more of the most commonly prescribed drugs. The regression was performed using the partial least squares (PLS) method (e.g., S. Wold, A. Ruhe, H. Wold, W. J. Dunn, SIAM J. Sci. Stat. Comput., 735 (1984) and R. Kramer, “Chemometric Techniques for Quantitative Analysis”, Dekker, New York, (1998)), which was particularly appropriate for this applications since it maximized the covariance between Y and X, helping make the resulting model optimally predictive. The data set was randomly separated into a training set (approximately 80% of the providers) and a test set (approximately 20% of the providers). The PLS method was used to fit the model based on only the training data set. The number of latent variables used in the PLS approach was determined by breaking up the training data into 10 subsets, leaving out each subset and fitting the remaining data, predicting the subset data, and maximizing the total root mean square error in the predictions as a function of the number of latent variables. This method is generally referred to as cross validation. Based on the regression, a function, Y=R(X) was established. This result could be used with the same or other providers to predict treatment rates from script data.

The accuracy of the relation R determined by regression was tested by using the test data set, which was not used at all in the fitting, and therefore represented the accuracy of the method on entirely new data. The regression model determined from the training data was used to predict the 33% of providers with the lowest treatment rates for the test data, and the predicted results were compared with the true results.

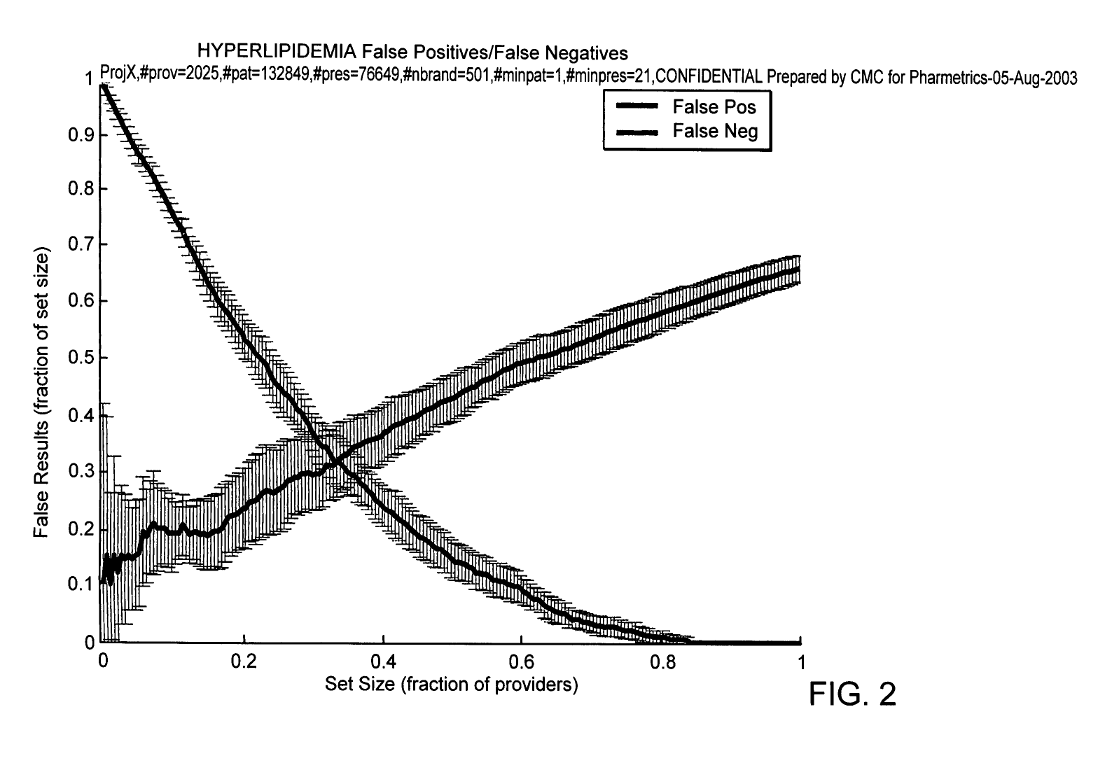

The results of the test are provided in the form of false positives and false negatives. A false positive means that using the script data and the regression function R a provider was predicted to be in the lowest 33% when the provider was not actually in the lowest 33% according to the claims data. A false negative means that a provider was not predicted to be in the lowest 33% based on R and the script data, but the provider is in fact in the lowest 33% according to the claims data. The results for a specific test can be seen in FIG. 2, where the fraction of false positives and negatives are plotted as a function of the number of candidate providers which are predicted to be in the lowest 33%. Note that the false positives are given as a percentage of the number of candidate providers, and the false negatives are given as a percentage of the true lowest 33% treatment rate providers for the test data.

The effectiveness of the method can be seen in this data. With no predictive ability (chance results), the false positive rate would be about 66%, as they are for the case where all providers are given as low treatment rate candidates, a prediction that contains no predictive information. However, for relatively few providers, the false positives are well below chance. For example, if the 33% of providers with the lowest predicted treatment rates are considered then the number of false positives is only about 38%, or slightly more than half that expected by chance. To assess whether these results might have resulted from chance, a shuffle test was performed. This involved randomly permuting all the treatment rates, so that the treatment rates and providers are no longer matched. The regression and test just described were performed again. The predictive ability of the method did not appear in the shuffled data, proving that the regression model was representing real correlations. This demonstrates that it is possible to create an effective predictive function for treatment rate from script data using regression and more complete claims data.

Having described embodiments of the present invention, it should be apparent that modifications can be made without departing from the scope of the invention as defined by the appended claims. For example, while examples have been given for different types of data that is used and how treatment rates are calculated, and the use of the results, other data can be used, rates can be measured, and uses can be made of the results.

1. A method comprising:
using medical claims data to determine a treatment rate for a number of medical providers based on treated and untreated patients;
using pharmacological script data that includes prescription behavior for treated patients, but does not include prescription behavior for untreated patients, to model the treatment rate determined from the medical claims data based on data contained in the script data; and
using the model to predict treatment rates for providers based on script data for such providers.

2. The method of claim 1, wherein the claims data is used to determine a treatment rate for one or more conditions indicative of how a provider treats such one or more conditions, the model being constructed by using as inputs script data to model treatment rates as a function of script data.

3. The method of claim 2, wherein the modeling includes using regression to construct the model with coefficients Rₙ for script data inputs Xₙ to derive a treatment rate.

4. The method of claim 2, wherein the modeling includes using a neutral network to construct the model with coefficients Rₙ for script data inputs Xₙ to derive a treatment rate.

5. The method of claim 1, wherein the predicted treatment rates are used to identify and classify prescription providers with relatively high and relatively low treatment rates.

6. The method of claim 6, wherein the prescription providers are classified into at least three groups based on the treatment rates.

7. The method of claim 6, further comprising using the prescription provider treatment rates to direct further advertising to the providers with lower treatment rates.

8. The method of claim 1, wherein predicting treatment rates for providers based on script data is performed by the owner of the script data using software that includes the model.

9. The method of claim 1, wherein predicting treatment rates for providers based on script data is performed by a third party service provider after receiving script data from the owner of the script data.

10. The method of claim 1, further comprising, for at least some of the providers a persistence rate indicting the rate at which patients stay on the prescribed therapy.

11. The method of claim 1, further comprising, for at least some of the providers a compliance rate indicting the rate at which patients comply with the prescribed therapy.

12. A method comprising:
using a superset of medical data to determine a parameter for a number of medical providers;
using a subset of the medical data from which the parameter cannot be directly determined to model the parameter determined from the superset based on data contained in the subset; and
using the model to predict the parameter for medical providers based on the subset of medical data for such providers.

13. The method of claim 12, wherein the subset is prescription script data and the superset is medical claims data.

14. The method of claim 12, wherein the parameter is a treatment rate.

15. The method of claim 12, wherein predicting the parameter for providers based on the superset of data is performed by the owner of the subset of data using software that includes the model.

16. The method of claim 12, wherein predicting the parameter for providers based on the superset of data is performed by a third party service provider after receiving the subset of data from the owner of the subset of data.

17. The method of claim 12, further comprising classifying the providers into at least two groups based on the values of the parameter, and targeting advertising to the providers based on the group the provider is in.
